(19) United States
(12) Patent Application Publication
(10) Pub. No.: US 2021/0339351 A1
(43) Pub. Date: Nov. 4, 2021

(54) PART POSITIONING JIG AND PART POSITIONING DEVICE USING THE SAME

(71) Applicant: TAIKOH CO., LTD., Toyota-shi, Aichi (JP)

(72) Inventor: Yasuharu ASAI, Toyota-shi, Aichi (JP)

(21) Appl. No.: 16/330,452

(22) PCT Filed: Jun. 21, 2018
(86) PCT No.: PCT/JP2018/023676

§ 371 Date: Mar. 5, 2019

(30) Foreign Application Priority Data
Oct. 17, 2017 (JP) 2017-201159

(51) Int. Cl. B23Q 3/18

(52) U.S. Cl. CPC B23Q 3/186; B62D 65/026

(57) ABSTRACT

Provided is a part positioning jig and a part positioning device using the same that allow the positioning in setting an assembling part on a dedicated tray to be carried out through a simple operation with no need for skill, whereby the part assembling work can be made more efficient and simpler. A part positioning jig is mounted to a bottom face of a part having machining reference holes for thereby aiding positioning of the part in assembling thereof, the part positioning jig including a base member in which at least one clamp installation part is disposed, an inner diameter clamp being installed in the clamp installation part such that a clamp head of the inner diameter clamp is protruded from a top face of the clamp installation part.

### CROSS-REFERENCE TO RELATED APPLICATIONS

This application claims priority to PCT Application No. PCT/JP2018/023676, having a filing date of Jun. 21, 2018, based off of Japanese Application No. 2017-201159, having a filing date of Oct. 17, 2017, the entire contents both of which are hereby incorporated by reference.

### FIELD OF TECHNOLOGY

The following relates to a part positioning jig and a part positioning device using the same, and more particularly to a part positioning jig and a part positioning device using the same that, for example, in assembling such a part as an engine, a transmission, a battery, or the like, to a body at an automobile assembling plant, allows the part to be positioned exactly and rapidly with respect to the body.

### BACKGROUND

In case of a production line at an automotive production plant, a body shell that has left a body painting line is sent to a final assembling line where a part called an outfit, such as an engine or a transmission, is assembled to the body shell.

For example, in the case where an engine is to be assembled, the engine has been previously manufactured at a separate plant, and carried to an assembling plant, where, after having been brought into the plant, it is placed on a dedicated tray (pallet) that has a receiving face corresponding to the irregularity of the bottom face of the engine before being carried by a conveyor to a transferring location, where it is transferred onto a part loading machine, being loaded on the lifter thereof. The part loading machine that has been put on the assembling line is moved in synchronization with the movement of the body shell, being conveyed in the state of being hung, and when the part loading machine reaches to under the body shell, the lifter is moved upward to lift the engine to an assembling level before an assembly worker making an assembling operation.

Conventionally, in placing a part on a dedicated tray, the head of a bolt or a cast surface that has been possessed by the part is utilized to perform an operation for satisfying the positioning accuracy including levelness for the part, however, such a positioning operation is a work that requires labor and skill of the assembling worker. The reason why the part must be precisely positioned at this stage is this; if it were not made, the subsequent assembling operation would not be conducted smoothly.

As a prior art for performing position adjustment of an engine assembly with respect to a body shell, there has been proposed a method wherein, after the engine assembly having been placed on a jig pallet, which has a plurality of jig pieces, the position of the engine assembly is detected by means of a part position detection sensor, and on the basis of the result of the detection, a movable jig piece, which is a part of the plurality of jig pieces, is moved for positioning of the engine assembly on the jig pallet (Japanese Unexamined Patent Application Publication No. 1994-56058).

As another prior art for performing position adjustment of an engine assembly with respect to a body shell, there has been proposed a method wherein, in a transfer apparatus, which receives an engine assembly that has been transferred thereto, being hung, a positioning pin is inserted into a positioning hole in the engine assembly, and around the positioning pin, the engine assembly is rocked to change the posture thereof into that for assembling, which is then followed by raising a placement board of the transfer apparatus from under the engine assembly to engage a plurality of pins of the placement board with positioning holes in the bottom face of the engine assembly to thereby performing position adjustment of the engine assembly (Japanese Unexamined Patent Application Publication No. 1994-31549).

### SUMMARY

Both of the apparatuses for implementing the methods according to the above proposals have drawbacks that they are complicated in mechanism, and require time and labor for setting a part (placing a part on the jig pallet or the placement board, involving positioning), also necessitating a certain degree of skill, which results in increased costs of equipment and working, and therefore it has been demanded to eliminate such drawbacks.

An aspect relates to a part positioning jig and a part positioning device using the same that, in setting a part on a dedicated tray after being brought into an assembling plant, allow the positioning thereof to be carried out through a simple operation with no need for skill, whereby the part assembling work can be made more efficient and simpler, resulting in the assembling efficiency for automobiles, and the like, being improved.

Embodiments of the invention provides a part positioning jig that is mounted or mountable to a bottom face of a part having machining reference holes for thereby aiding positioning of said part in assembling work, said part positioning jig including a base member in which at least one clamp installation part is disposed, an inner diameter clamp being installed in said clamp installation part such that a clamp head of said inner diameter clamp is protruded from a top face of said clamp installation part.

In one embodiment of the invention, said base member is formed in a letter-T shape, and at any two ends of the three ends thereof, said clamp installation part is disposed, while, in another embodiment of the invention, said base member is formed in a letter-L shape, and at the two ends thereof, said clamp installation part is disposed.

Further, in another embodiment of the invention, said base member is formed in a letter-I shape, and at both ends thereof, said clamp installation part is disposed. In this embodiment, at both ends of said base member, a hanging part may be disposed. Generally, said base member is used as a set of two.

In another embodiment of the invention, a cushioning member is fixed at a desired location of a top face of said base member.

Embodiments of the invention provide a part positioning device, including a part positioning jig and a dedicated tray for receiving this, said dedicated tray being provided with, on a base plate thereof, with a pair of positioning walls having a gap the width of which corresponds to the width of said base member, and with said base member being dropped into said gap of the pair of positioning wall, said part positioning jig in the state of having been mounted to said part being positioned on said dedicated tray.

In one embodiment of the invention, the positioning wall of said dedicated tray is one which is formed in the shape of a letter L.

The following is as described above, and it offers advantages that the part positioning jig can be simply mounted to a bottom face of a part through an inner diameter clamp thereof, whereby a part, such as an engine, that has a complicated bottom face, can be handled extremely easily as if it had a flat surface; thus, the part can be handled with extreme ease at the time of a subsequent stock operation in the plant, placing it on a pallet for conveyance to an assembling plant, conveying it to the same, and the like, which will be led to a cost reduction.

In addition, with embodiments of the present invention, there is an advantage that the part to which the part positioning jig has been mounted can be placed on the dedicated tray, while being positioned with a high accuracy including levelness, and, until the part is carried to an assembling operation site through the subsequent transfer operations that are to be made many times, the positioning accuracy can be maintained, which allows the assembling operation of the part to be smoothly progressed, resulting in a substantial improvement in assembling efficiency.

### BRIEF DESCRIPTION

Some of the embodiments will be described in detail, with reference to the following figures, wherein like designations denote like members, wherein:

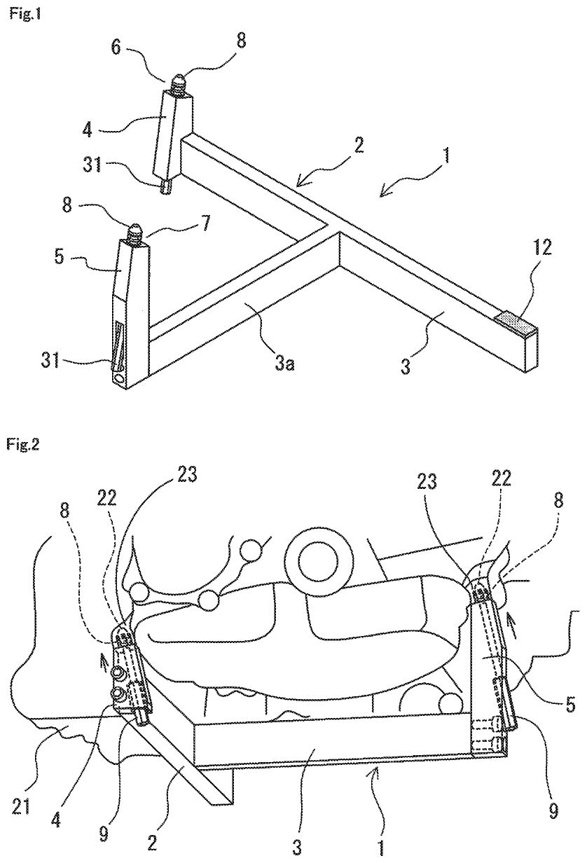

FIG. 1 is a perspective view showing a part positioning jig of a first embodiment in accordance with embodiments of the present invention;

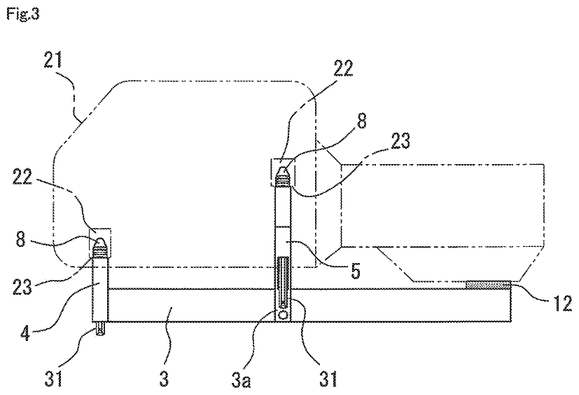

FIG. 2 is a perspective view showing the state in which the part positioning jig of the first embodiment in accordance with embodiments of the present invention is mounted on the bottom face of an engine;

FIG. 3 is a front view showing the part positioning jig of the first embodiment in accordance with embodiments of the present invention;

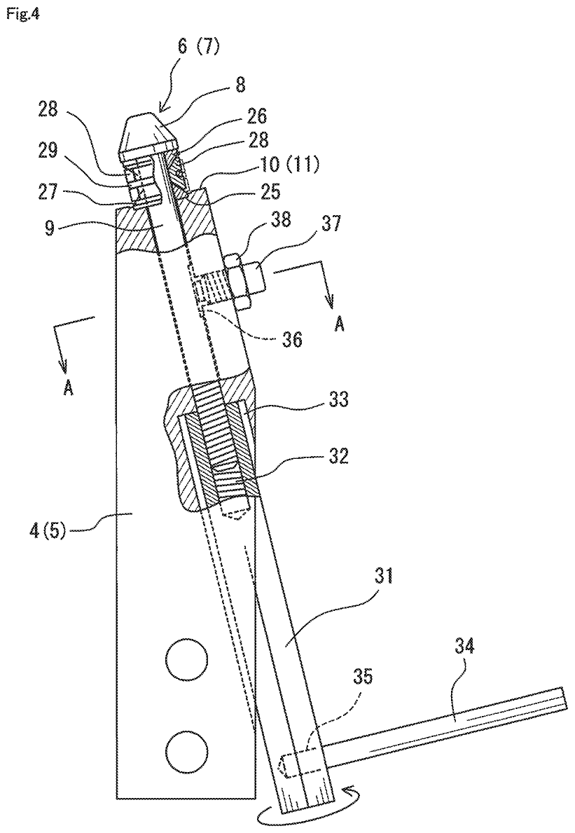

FIG. 4 is a partial sectional view showing the configuration of an inner diameter clamp in the part positioning jig in accordance with embodiments of the present invention;

FIG. 5 is a front view of a drive shaft constituting the inner diameter clamp in the part positioning jig in accordance with embodiments of the present invention;

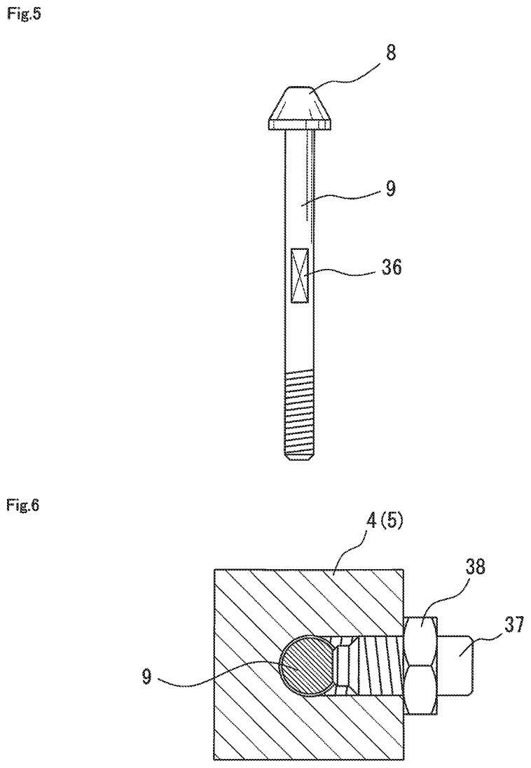

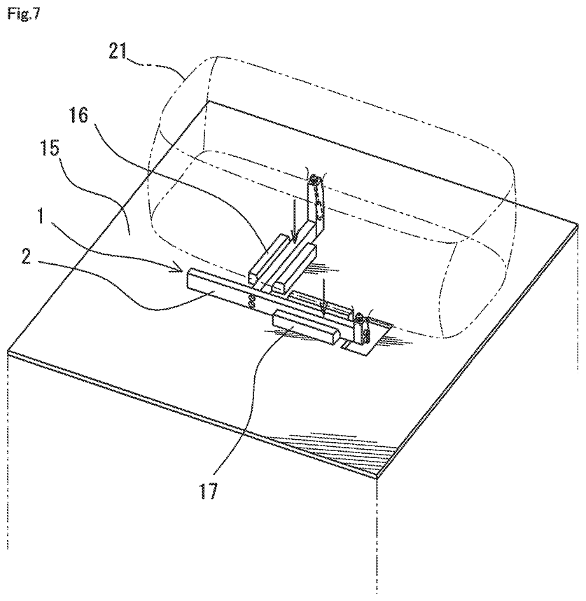

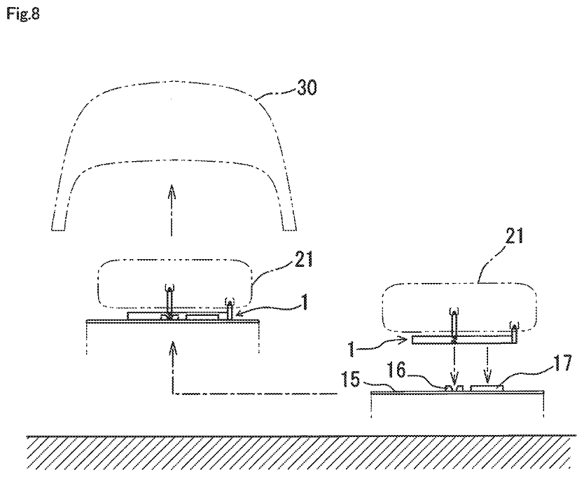

FIG. 6 is an enlarged sectional view along the line A-A in FIG. 4;

FIG. 7 is a perspective view illustrating the method of setting the part positioning jig of the first embodiment in accordance with embodiments of the present invention on a dedicated tray for positioning a part;

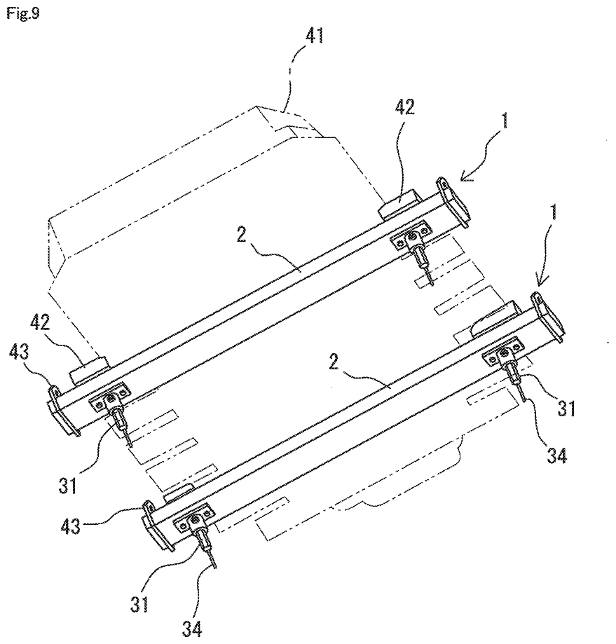

FIG. 8 is a perspective view illustrating the method of setting the part positioning jig of the first embodiment in accordance with embodiments of the present invention on a dedicated tray and transferring it;

FIG. 9 is a rear-face perspective view showing the mounting state of a part positioning jig of a third embodiment in accordance with embodiments of the present invention;

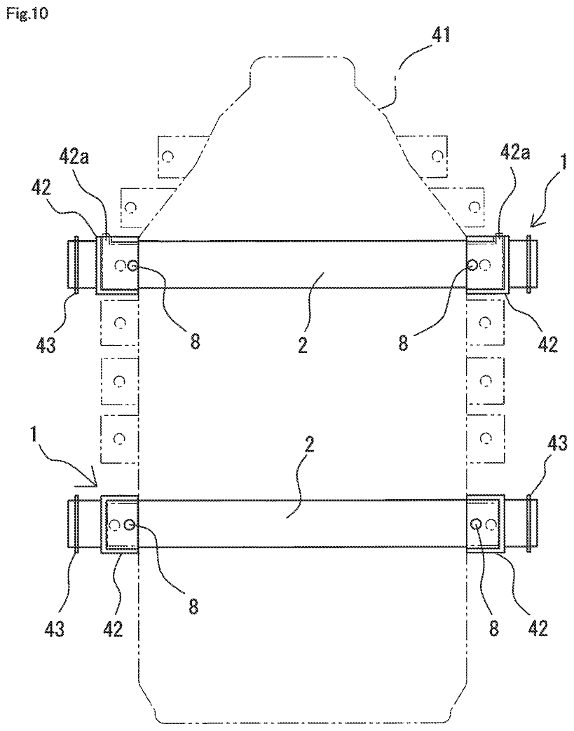

FIG. 10 is a plan view showing the mounting state of the part positioning jig of the third embodiment in accordance with embodiments of the present invention;

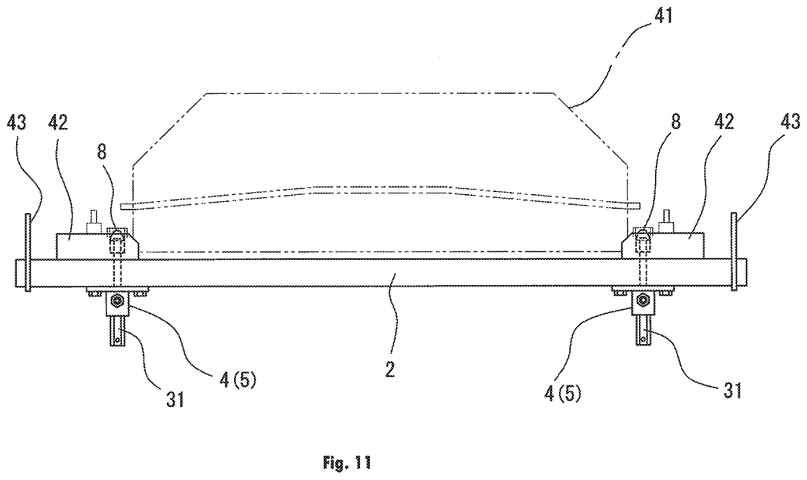

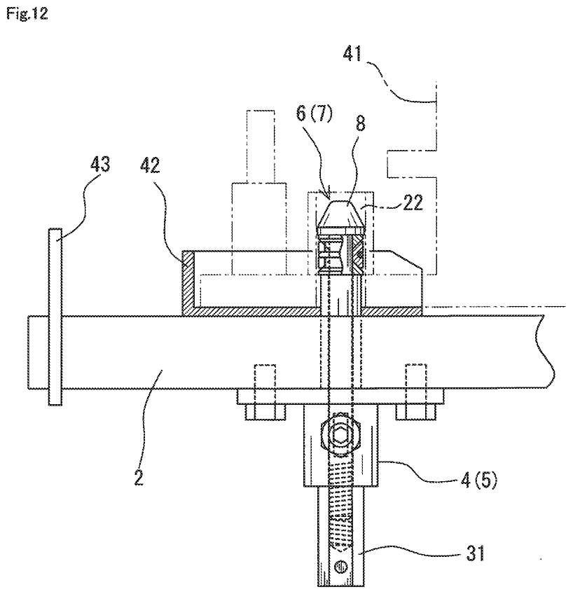

FIG. 11 is a front view of the part positioning jig of the third embodiment in accordance with embodiments of the present invention;

FIG. 12 is a partial sectional view showing the critical portion of the part positioning jig of the third embodiment in accordance with embodiments of the present invention; and

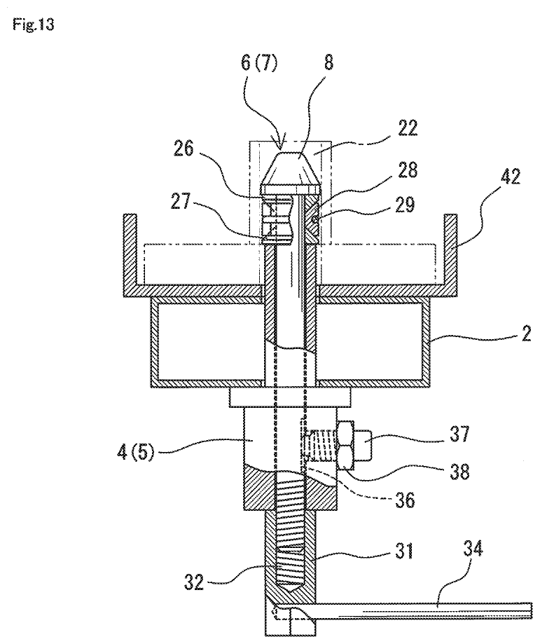

FIG. 13 is a partial sectional view showing the critical portion of the part positioning jig of the third embodiment in accordance with embodiments of the present invention.

### DETAILED DESCRIPTION

Hereinbelow, embodiments for implementing the present invention will be explained with reference to the attached drawings. The following explanation is an explanation with the assumption that the part is an engine or a battery. However, the same explanation is also applicable to other parts, such as a transmission, and the part positioning jig and the part positioning device using the same in accordance with embodiments of the present invention can be applied not only to automobile assembling lines, but also to lines for manufacturing other large-sized machines.

Parts to be assembled, such as engines, generally have a machining reference hole and a reference face that have been formed in the block working. The part positioning jig in accordance with embodiments of the present invention that will be described hereinafter is mounted or mountable to the bottom face of such a part in a temporal manner rather than a permanent one with the use of the machining reference hole and the reference face that are formed in that part, thereby making the operation of positioning the relevant part in the subsequent treating process extremely easy.

FIG. 1 to FIG. 3, the part to be positioned is an engine 21. As shown in the figures, with the part positioning jig 1 in accordance with embodiments of the present invention, a clamp installation part 4, 5 is disposed at the two ends of a base member 2, and the clamp installation part 4, 5 is equipped with an internal clamp 6, 7, respectively. Further, as described hereinbelow in detail, the part positioning jig 1 is mounted or mountable to the bottom face of the engine 21 with the clamp head 8 of the respective internal clamps 6, 7 being inserted into the machining reference hole 22 of the engine 21 for clamping the pertinent portion.

Still further, the base member 2 in the embodiment shown in FIG. 1 to FIG. 3 is formed in a letter-T shape, the clamp installation part 4, 5 being disposed at one end of a horizontal member 3 constituting the base member 2 and at the end of a vertical member 3a that is on the side opposite to that on which it is jointed to the horizontal member 3. The clamp installation part 4, 5 may be disposed at both ends of the horizontal member 3 or at both ends of the vertical member 3a. A cushioning member 12 is fixed at a desired location of a top face of the base member 2 that receives a bottom face of the engine 21.

The internal clamp 6, 7 provides a clamping jig that can be fixed to the machining reference hole 22 by inserting a clamp head 8, which can be expanded or contracted in a radial direction as the driving shaft 9 is turned, into the machining reference hole 22 in the engine 21, and causing the clamp head 8 to make an expansion operation for pressing it against the internal circumference wall of the machining reference hole 22 (see FIG. 4). In more detail, the clamp head 8 of the internal clamp 6, 7 is comprised of an upper cone 26, which is fixed to the tip part of the driving shaft 9, and is turned integrally with the driving shaft 9, a lower cone 27, through which the driving shaft 9 is passed, and a plurality of movable pieces 28, which are disposed between the upper and lower cones 26, 27, and the tapered circumferential faces of which are in sliding contact with the upper cone 26 and the lower cone 27, the plurality of movable pieces 28 being embraced by an O-ring 29 or a C-ring in a slightly movable state.

The internal clamp 6, 7 is installed in the clamp installation part 4, 5 with the driving shaft 9 being aligned with the orientation of the machining reference hole 22 formed in the engine 21, to which the part positioning jig 1 is to be mounted, and a turning operation member 31 for turning the driving shaft 9 being exposed. In the upper end portion of the turning operation member 31, there is provided a female thread part 32, and the upper half portion thereof being inserted into the insertion part 33, which is formed obliquely in the clamp installation part 4, 5, and the lower end male part of the driving shaft 9 being screwed in the female thread part 32. The turning operation member 31 is advanced until the top face thereof is butted against the internal top face of the insertion part 33 (the state as shown in FIG. 4).

The turning operation member 31 is turned by, for example, inserting an operation bar 34 into an insertion hole 35, which is formed in the lower portion thereof. When the turning operation member 31 is turned, the driving shaft 9, which is screwed in the female thread part 32 thereof, will be vertically moved, since the top face of the turning operation member 31 is butted against the internal top face of the insertion part 33, thereby being unable to be vertically moved. There is provided a means for preventing the driving shaft 9 from being turned. In an example as given in the figure, a flat face 36 is formed in the middle portion of the driving shaft 9, and a setscrew (hexagon socket head setscrew) 37 is driven in from an outside face of the clamp installation part 4, 5 toward the flat face 36 (see FIG. 5, 6). The setscrew 37 is advanced or retracted by screwing it into a nut 38 or out therefrom, the nut 38 being fixed to the outside face of the clamp installation part 4, 5, and when advanced, it presses the flat face 36 to prevent the driving shaft 9 from being turned, while, when retracted, it gets away from the flat face 36 to allow the driving shaft 9 to be turned.

The top face of the clamp installation part 4, 5 is adapted to be a positioning face 10, 11 that is to be butted against the reference face 23, which is provided for the bottom face of the engine 21 together with the machining reference hole 22 (see FIG. 4). In mounting the part positioning jig 1 to the engine 21, by butting this positioning face 10, 11 against the reference face 23 of the engine 21, the positional accuracy of the part positioning jig 1 with respect to the engine 21 is improved (see FIG. 2). In the positioning face 10, 11, a double step hole 25 is formed, and in the recess around the central hole, the lower cone 27 of the internal clamp 6, 7 is fitted (see FIG. 4). The lower cone 27 is accommodated in the recess around the central hole for pinching the movable piece 28 between it and the upper cone 26.

For causing the internal clamp 6, 7 to act on the machining reference hole 22, the clamp head 8 is inserted into the machining reference hole 22 until the positioning face 10, 11 of the clamp installation part 4, 5 is butted against the reference face 23. Then, when the turning operation member 31 is operated to turn the driving shaft 9 in a clamping direction (screwing-out direction), the driving shaft 9 is pulled in a downward direction. Along therewith, the upper cone 26 is moved downward while being turned to be brought closer to the lower cone 27, heavily pinching the respective movable pieces 28 between it and the lower cone 27. Thereby, the respective movable pieces 28 are pushed out in a radial direction, while being pushed downward, heavily pressing the internal circumferential face of the machining reference hole 22. As a result of this, the internal clamp 6, 7 is fixed to the machining reference hole 22, whereby it will not be removed. Thus, the part positioning jig 1 is reliably fixed to the bottom face of the engine 21.

The part positioning jig 1 in accordance with embodiments of the present invention is set in place on the dedicated tray 15. The dedicated tray 15 is used to load the engine 21 thereon that has been carried into an assembling plant, for conveying it to a part assembling operation site in the plant and lifting it to an assembling level. With the dedicated tray 15 that is used in a first embodiment, wherein the base member 2 provides a letter-T shape, a pair of positioning walls 16, 17 are disposed on a base plate of the dedicated tray 15 at right angles, the pair of positioning walls 16, 17 being constituted by a double wall having a gap, respectively, that corresponds to the width of the horizontal member 3 and the vertical member 3a, which constitute the base member 2 (see FIG. 7).

When the part positioning jig 1 is lowered on the dedicated tray 15, the horizontal member 3 is dropped into the gap of the positioning wall 17, while the vertical member 3a being dropped into the gap of the positioning wall 16, whereby, on the dedicated tray 15, the part positioning jig 1 and the engine 21, to which the part positioning jig 1 is mounted, are set, being automatically positioned.

Next, how to use the part positioning jig 1 in accordance with embodiments of the present invention will be explained. Before using it, of a plurality of machining reference holes that are formed in the external bottom face of the engine 21, the machining reference hole 22 that is to be used for mounting the part positioning jig must be selected, and it must be confirmed that the driving shaft 9 of the corresponding internal clamp 6, 7 is oriented to a direction in which that machining reference hole 22 is drilled. In this way, the part positioning jig 1 can be repeatedly used for the same type of engines 21 with which the machining reference hole 22 is provided in the same location.

Next, to the bottom face of the engine 21 that is conveyed, being hung, the part positioning jig 1 is mounted temporarily rather than permanently by inserting the clamp head 8 of the internal clamp 6, 7 into the machining reference hole 22 and fixing thereto. The clamp head 8 of the internal clamp 6, 7 is expanded or contracted in a radial direction along with the turning operation of the driving shaft 9. After inserting such clamp head 8 into the machining reference hole 22 of the engine 21, by operating the turning operation member 31 to turn the driving shaft 9, the internal clamp 6, 7 is expanded to clamp the machining reference hole 22 from the inside, thereby the part positioning jig 1 being temporarily mounted to the bottom face of the engine 21.

Thus, the engine 21 with which the part positioning jig 1 has been mounted thereto will not be directly seated by the bottom face itself when being loaded, and instead the part positioning jig 1 will be seated, whereby it will be possible to handle the engine 21 extremely easily as if the bottom face thereof were flat. Therefore, if the mounting operation of the part positioning jig 1 is made in an engine manufacturing plant, a subsequent stock operation of the engine in the plant, loading it onto a pallet for conveying the engine to an assembling plant, and the like, will be made extremely easily, which will be led to a cost reduction.

The engine 21 that has been carried into an assembling plant, the part positioning jig 1 being mounted thereto, is lowered onto the dedicated tray 15, and the horizontal member 3 and the vertical member 3a, which are jointed to each other at right angles, are accommodated in the gap of the positioning wall 16, 17, respectively, whereby the part positioning jig 1, in other words, the engine 21 can be set, being positioned in place on the dedicated tray 15.

The dedicated tray 15 on which the engine 21 has been loaded is conveyed to the part assembling operation site, i.e., to under the body shell 30 in the state of being hung, by an appropriate conveying means, and transferred onto a lifter of a part loading machine before the dedicated tray 15 being raised to the part assembling level, where the engine 21 is manually assembled to the body shell 30 (see FIG. 8). The part positioning jig 1 is removed after assembling of the part has been completed.

The following is as described above, and it allows the part positioning jig to be easily mounted to the bottom face of an engine through the inside diameter clamp at a part manufacturing plant, or the like, whereby the engine will be made possible to be handled extremely easily as if it had a flat bottom face, and the part positioning jig can be extremely easily set on a dedicated tray; thus, the part can be handled with extreme ease at the time of a subsequent stock operation in the plant, placing it on a pallet for conveyance to an assembling plant, conveying it to the same, and the like, which will be led to a cost reduction.

The base member 2 in the first embodiment as described above is formed in a letter-T shape, however, it may be adapted to be formed in a letter-L shape, in other words, in a second embodiment, the horizontal member 3 and the vertical member 3a are jointed to each other such that they provides two sides forming a right angle. In this case, the clamp installation part 4, 5 is disposed at the two ends of the base member 2 in the shape of a letter L that is formed by jointing the horizontal member 3 and the vertical member 3a to each other, or in an area where these members intersect at right angles with each other. The dedicated tray 15 for use in this second embodiment is the same as that in the first embodiment as described above.

The base member 2 in a third embodiment is a single hollow or solid plate-like member in the shape of a letter I as shown in FIG. 9 to FIG. 13. In FIG. 9 to FIG. 13, a portion having the same sign as in FIG. 1 to FIG. 8 are provided with the same configuration as that of the corresponding portion in the first embodiment, and thus detailed explanation thereof will be omitted. In this third embodiment, as a part to be assembled, a battery 41 is assumed, and generally, the part positioning jig 1 is used as a pair of two.

The clamp installation part 4, 5 is provided at both ends of the base member 2 such that it penetrates vertically therethrough, being embedded therein, with the internal clamp 6, 7 being protruded on the top face side, while the turning operation member 31 being protruded on the bottom face side. In addition, at both ends of the base member 2, a frame member 42 is disposed. This frame member 42 accommodates the protruding end of the battery 41, protecting that portion, and also serving as a positioning member in inserting the clamp head 8 of the internal clamp 6, 7 into the machining reference hole 22. As shown in FIG. 10, there may be formed a side protruding part at the protruding end of the battery 41, and in that case, the frame member 42 is provided with a notch 42a for relieving the side protruding part.

Further, at both ends of the base member 2, a hanging part 43 is disposed. This hanging part 43 is provided for engaging a hook therewith in conveyance performed by use of a crane.

In this third embodiment, the clamp head 8 of the internal clamp 6, 7 of a first one of the two part positioning jigs 1 is inserted into the machining reference hole 22 in the bottom face of the battery 41, and by operating the turning operation member 31 to cause the internal clamp 6, 7 to make an expansion action for fixing it to the machining reference hole 22 to thereby mount the first one of the two part positioning jigs 1 to the bottom face of the battery 41. Next, a second one of the part positioning jigs 1 is mounted in the same way to the bottom face of the battery 41 (see FIG. 9). Hereinafter, the battery can be transferred to the site of the respective processes by utilizing the hanging part 43.

The dedicated tray 15 in this third embodiment is adapted to have a width narrower than the spacing between the turning operation members 31, 31, which are protruded on the bottom face side of the base member 2, or provided with an opening for relieving the turning operation member 31.

Hereinabove, embodiments of the present invention has been explained about various embodiments, however, embodiments of the present invention is not limited to these embodiments, and may be subjected to various modifications within the scope of the technical concept of embodiments of the present invention. For example, the shape of the base member is not limited to the letter-T, letter-L, and letter-I ones, which have been mentioned above, but may be a cross, triangle, or any other shape.

The part positioning jig in accordance with embodiments of the present invention can be simply mounted to the bottom face of a part, whereby a part having a complicated bottom face is made possible to be handled extremely easily as if it had a flat bottom face, and the part positioning jig can be extremely easily set on a dedicated tray; thus, the part can be handled with extreme ease at the time of a subsequent stock operation in the plant, placing it on a pallet for conveyance to an assembling plant, conveying it to the same, and the like

In addition, the part to which the part positioning jig has been mounted can be placed on the dedicated tray, while being positioned with a high accuracy including levelness, and, until the part is carried to an assembling operation site through the subsequent transfer operations that are to be made many times, the positioning accuracy can be maintained, which allows the assembling operation of the part to be smoothly progressed, resulting in a substantial improvement in assembling efficiency, and thus the industrial applicability for the part positioning jig in accordance with embodiments of the present invention is extremely great.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A part positioning jig that is mountable to a bottom face of a part having machining reference holes for thereby aiding positioning of said part in assembling thereof, said part positioning jig comprising:
a base member in which at least one clamp installation part is disposed; and
an inner diameter clamp being installed in said clamp installation part such that a clamp head of said inner diameter clamp is protruded from a top face of said clamp installation part.

2. The part positioning jig according to claim 1, wherein said base member is formed in a letter-T shape having three ends, and at any two ends of the three ends thereof, said clamp installation part is disposed.

3. The part positioning jig according to claim 1, wherein said base member is formed in a letter-L shape, and at the two ends thereof, said clamp installation part is disposed.

4. The part positioning jig according to claim 1, wherein said base member is formed in a letter-I shape having two ends, and at both of the two ends, said clamp installation part is disposed.

5. The part positioning jig according to claim 4, wherein, at both of the two ends of said base member, a hanging part is disposed.

6. The part positioning jig according to claim 1, wherein a cushioning member is fixed at a desired location of a top face of said base member.

7. A part positioning device, comprising a part positioning jig claimed in claim 1 and a dedicated tray for receiving this,
said dedicated tray being provided with, on a base plate thereof, a pair of positioning walls having a gap the width of which corresponds to the width of said base member, and with said base member being dropped into said gap of the pair of positioning wall, said part positioning jig in the state of having been mounted to said part being positioned on said dedicated tray.

8. The part positioning jig according to claim 7, wherein the positioning wall of said dedicated tray is formed in the shape of a letter L.
